(19) United States
(12) Patent Application Publication
(10) Pub. No.: US 2013/0155535 A1
(43) Pub. Date: Jun. 20, 2013

(54) INTEGRATED SOLAR CONCENTRATOR SYSTEM

(71) Applicant: Ronald O. Woodward, Yorktown, VA (US)

(72) Inventor: Ronald O. Woodward, Yorktown, VA (US)

(21) Appl. No.: 13/817,500

(22) PCT Filed: Aug. 16, 2011
(86) PCT No.: PCT/US2011/001433

§ 371 Date: Feb. 18, 2013

Related U.S. Application Data
(60) Provisional application No. 61/401,613, filed on Aug. 16, 2010.

(51) Int. Cl. G02B 5/10

(52) U.S. Cl. CPC G02B 5/10
USPC 359/853

(57) ABSTRACT

An integrated solar concentrator assembly (10) which is built to allow an opposing criss-cross optics pattern, creating a more compact, structurally sound unit having a nearly perpendicular light path into a mixing optic (32). This improves optical efficiency and allows for the mixing optic (32) to have a flat outer surface, thereby improving manufacturability. This criss-cross optical pattern also allows the opposite mirror structure to be used to support the solar receiver components, eliminating additional brackets. The configuration of the integrated solar concentrator assembly (10) allows frame mounts to be placed on the outboard corners of the assembly, improving the inherent aim accuracy, as well as simplifying installation.

### CROSS-REFERENCE TO RELATED APPLICATIONS

This application claims priority to U.S. Provisional Application No. 61/401,613 filed on Aug. 16, 2010. The disclosure of the above application is incorporated herein by reference.

### FIELD OF THE INVENTION

The present invention relates to a solar concentrator system which has several integrated components.

### BACKGROUND OF THE INVENTION

Current concentrating solar power optics systems are complex and costly to manufacture, and are typically composed of many molded reflector elements and solar cell receivers assembled on a frame. This poses many problems with cost and accuracy during assembly. Furthermore, the mixing optic in the receiver is expensive and difficult to manufacture.

Accordingly, there exists a need to develop a lower cost, simpler solar concentrator system which can be assembled quickly and accurately using fewer, easier to manufacture parts on a simple frame.

### SUMMARY OF THE INVENTION

The present invention is an integrated solar concentrator assembly which is built to allow an opposing criss-cross optics pattern, creating a more compact, structurally sound unit having a nearly perpendicular light path into a mixing optic. This improves optical efficiency and allows for the mixing optic to have a flat outer surface, thereby improving manufacturability. This criss-cross optical pattern also allows the opposite mirror structure to be used to support the solar receiver components, eliminating additional brackets. The configuration of the integrated solar concentrator assembly allows frame mounts to be placed on the outboard corners of the assembly, improving the inherent aim accuracy, as well as simplifying installation.

The cost of manufacture is reduced by simplifying the mixing optic and combining many reflector brackets and cell receiver brackets into one molded piece containing the mirrors, mixing optic, and cell-heatsink assembly.

The system also provides for lower part count, lower overall system cost, improved aim accuracy, lower sensitivity to assembly variation, and ease of assembly in the field.

In one embodiment, the integrated solar concentrator system includes a reflector body molding, a frame rail integrally formed with the reflector body molding, and a mirror mount surface having at least one concave mirror surface mounted to the reflector body molding. A receiver housing is molded as part of the reflector body molding and mounted to the frame rail.

A mixing lens is disposed within the receiver housing, and operable for receiving light from the concave mirror surface. The system also includes a heatsink solar cell assembly connected to the receiver housing operable for receiving light from the mixing lens.

A heatshield/mixing lens retainer is mounted to the receiver housing, the heatshield/mixing lens retainer maintains the position of the mixing lens in the receiver housing. Light is reflected off of the concave mirror surface and directed toward the mixing lens, where the light passes through the mixing lens such that the mixing lens focuses and directs the light to the heatsink solar cell assembly.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a solar concentrator system, according to the present invention;

FIG. 2 is a perspective view of two mixing lenses used in a solar concentrator system, according to the present invention;

FIG. 3 is a first perspective view of a receiver housing used in a solar concentrator system, according to the present invention;

FIG. 4 is a second perspective view of a receiver housing used in a solar concentrator system, according to the present invention;

FIG. 5 is an exploded view of a receiver housing, a mixing lens, and a heatshield/mixing lens, used in a solar concentrator system, according to the present invention;

FIG. 6 is a perspective view of the corner of a reflector body molding having an incorporated mounting tab, used in a solar concentrator system, according to the present invention;

FIG. 7 is a cross-sectional view of a solar concentrator system taken along lines 7-7 of FIG. 1, according to the present invention; and

FIG. 8 is a cross-sectional view of the circled portion shown in FIG. 7.

### DETAILED DESCRIPTION OF THE PREFERRED EMBODIMENTS

The following description of the preferred embodiment(s) is merely exemplary in nature and is in no way intended to limit the invention, its application, or uses.

Referring to the Figures generally, an overall view of a solar concentrator assembly according to the present invention is shown generally at 10. The solar concentrator assembly 10 is made up of the reflector body molding 12 with incorporated features, such as a plurality of mounting tabs, shown generally at 14, a frame rail 16, a mirror mount surface, shown generally at 18, and a plurality of receiver housings 20. In this embodiment, the mirror mount surface 18 is made several smaller concave mirror surfaces in the form of a first concave mirror surface 18A, a second concave mirror surface 18B, a third concave mirror surface 18C, a fourth concave mirror surface 18D, a fifth concave mirror surface 18E, and a sixth concave mirror surface 18F. There are also several attached components, which in this embodiment are heatsink solar cell assemblies, shown generally at 22, each of which includes a heatshield/mixing lens retainer 24.

Each mounting tab 14 includes two side flanges 26, and a middle flange 28 having an aperture 30. A fastener (not shown) is inserted through the aperture 30 to mount the assembly 10 as desired.

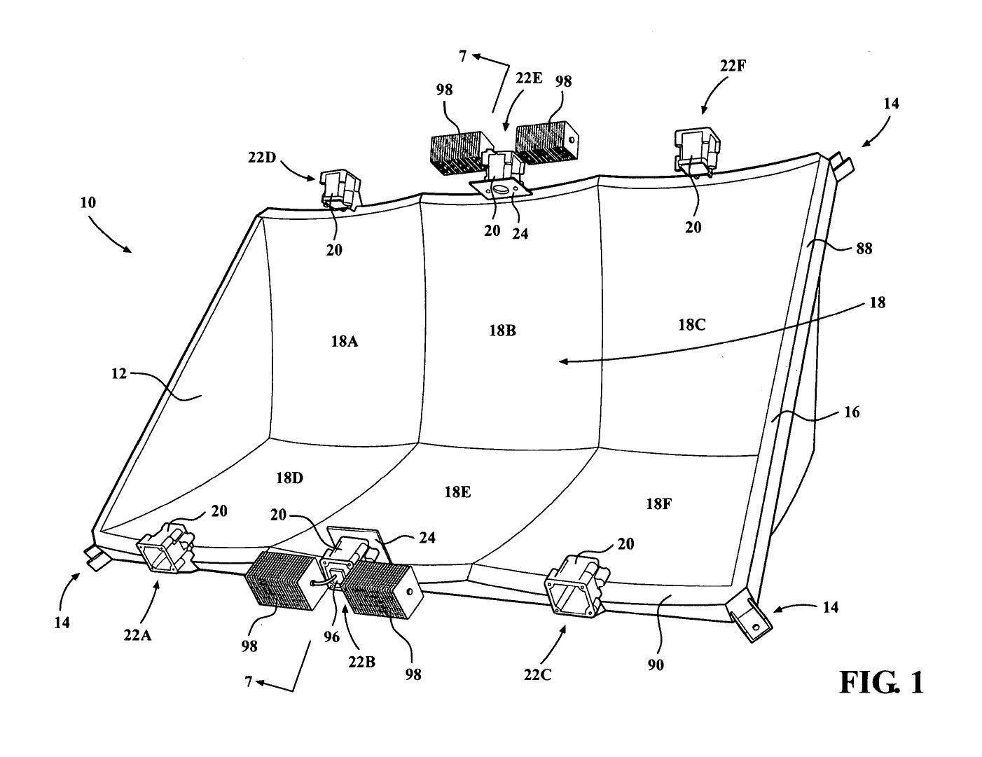

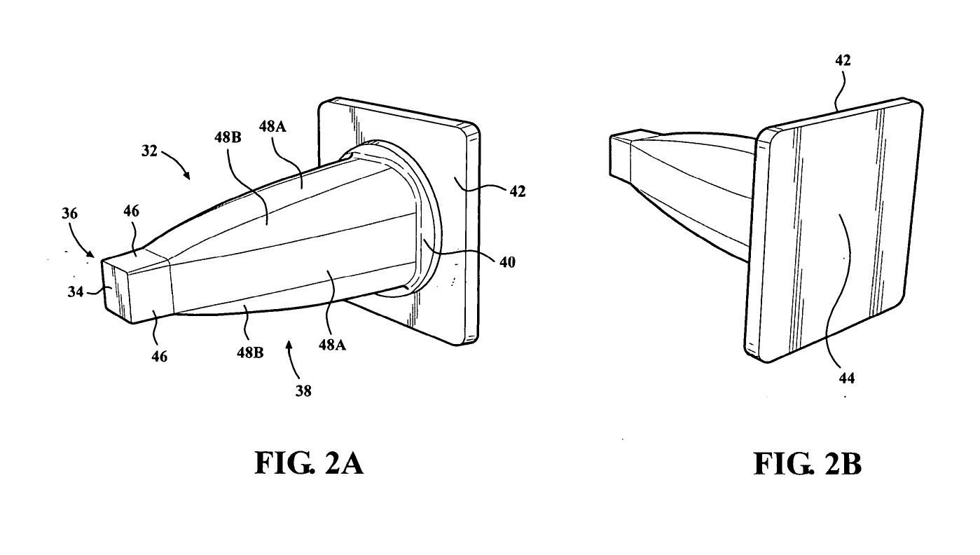

Each receiver housing 20 is connected to a heatshield/mixing lens retainer 24. At least partially disposed within each housing 20 is a mixing lens, shown generally at 32. The receiver housing 20, heatsink solar cell assembly 22, heatshield/mixing lens retainer 24, and mixing lens 32 form a concentration assembly. In this embodiment, there are six concentration assemblies mounted on each side of the mirror mount surface 18 as shown in FIG. 1. However, for demonstrative purposes, only two complete concentration assemblies are shown. Only the receiver housings 20 for the remaining concentration assemblies are shown.

The mixing lens 32 includes a substantially flat output port 34 connected to a first optical section, shown generally at 36. The mixing lens 32 couples light through an index matching jell (not shown) to a solar cell (not shown). The first optical section 36 is connected to a second optical section, shown generally at 38, and the second optical section 38 is connected to a step portion 40. The step portion 40 is connected to a mounting flange 42, which has a substantially flat input port 44.

The mounting flange 42 is substantially square-shaped, which provides for proper alignment of the orientation of the mixing lens 32 with a square-shaped solar cell. The step portion 40 also functions to provide a sealing surface for an O-ring 100. The first optical section 36 is has a plurality of flat tapered walls 46, each of which is connected to the flat output port 34. The flat tapered walls 46 are also connected to the second optical section 38. In this embodiment, the first optical section 36 is a blending optical section 36. The second optical section 38 in this embodiment is a parabolic optical section 38, having flat surfaces 48A and parabolic surfaces 48B. The light enters through the flat input port 44, and the optical sections 36,38 use total internal reflection (TIR) to provide for the focusing of off-axis rays using the parabolic section 38 and blending from the flat tapered walls 46.

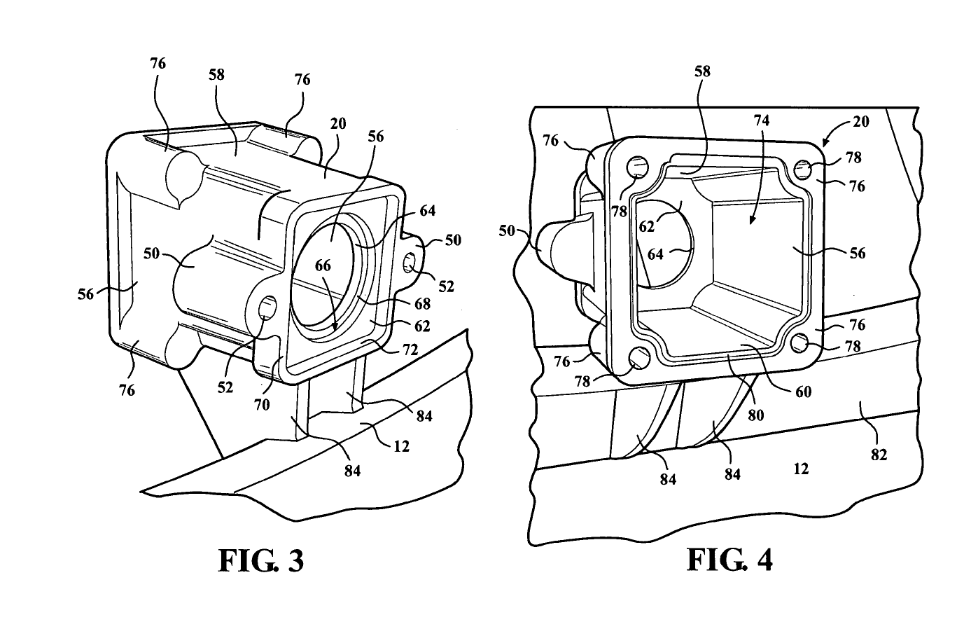

Referring now to FIGS. 3 and 4, the receiver housing 20 is molded as an integral part of reflector body molding 12. The receiver housing 20 has attachment features 50, which are integrally molded as part of the housing 20, and each attachment feature 50 has an aperture 52. Each aperture 52 is in alignment with a corresponding aperture 54 formed as part of the heatshield/mixing lens retainer 24. A fastener (not shown) such as a bolt is operable for extending through the aperture 54 and into the aperture 52 to secure the retainer 24 to the housing 20.

The housing 20 is substantially box-shaped, and has two outer walls 56, upon which the attachment features 50 are mounted. There is also an upper wall 58 and a lower wall 60. The housing 20 also has a rear wall portion 62, and the rear wall portion 62 has an aperture 64. The rear wall portion 62 includes a stepped feature, shown generally at 66, which has a sealing surface 68, which functions as O-ring sealing surface. The O-ring 100 is disposed between the O-ring sealing surface 68 and the mounting flange 42, and circumscribes the step portion 40 when the mixing lens 32, the housing 20, and the retainer 24 are assembled together. Once the retainer 24 is secured to the housing 20, the mounting flange 42 is disposed between the retainer 24 and the rear wall portion 62 of the housing 20, and the flange 42 is also surrounded by the inner surface 72.

There is also a lip portion 70 formed as part of the housing 20, and the lip portion 70 surrounds the rear wall portion 62, best seen in FIG. 3. The lip portion 70 has an inner surface 72, which functions an an alignment feature. More specifically, the inner surface 72 surrounds the mounting flange 42 when the mixing lens 32 is assembled to the housing 20. Referring now to FIG. 4, the receiver housing 20 has a cavity, shown generally at 74, formed by the walls 56,58,60. Also shown in FIG. 4 are attachment features 76 formed as part of the housing 20; the attachment features 76 are arranged in a square pattern at the corners of where the walls 56,58,60 connect, which facilitates mounting in any of four orientations. Each attachment feature 76 includes an aperture 78 used for receiving a fastener (not shown) such as a bolt. The heat sink solar cell assembly 22 is connected to the housing 20 through the use of the attachment features 76.

Formed as part of each of the walls 56,58,60 the housing 20 is a groove 80, which at least partially surrounds the cavity 74. The groove 80 is used to retain an elastomeric seal (not shown) to provide weather tightness between the housing 20 and the heat sink solar cell assembly 22 when the assembly 22 is attached to the housing 20. The reflector body molding 12 is formed with at least one molded in stiffness flange 82, which provides support for attachment ribs 84. The attachment ribs 84 are connected to the frame rail 16 by molding the housing 20, the stiffness flange 82, and ribs 84 as a single unit. In an alternate embodiment, the ribs 84 and housing 20 are molded separately from the frame rail 16, and attached to the stiffness flange 82 and frame rail 16 through an adhesive, fasteners, or the like.

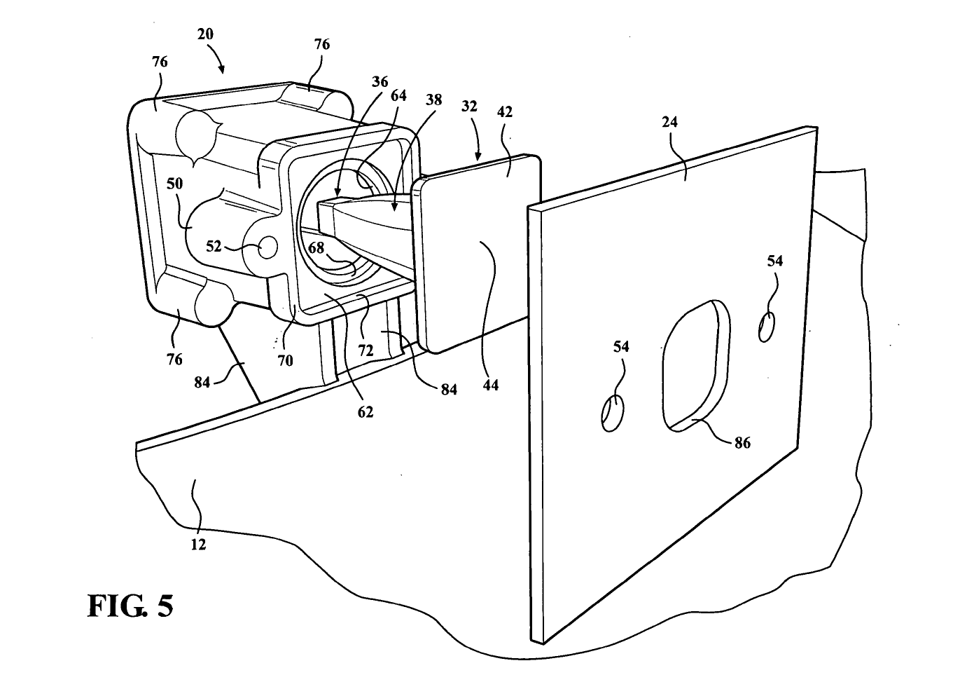

FIG. 5 is an exploded view of the receiver housing 20, the mixing lens 32, and the heatshield/mixing lens retainer 24. The heatshield/mixing lens retainer 24 includes a central aperture 86 which is substantially the same shape and circumference as the portion of the second optical section 38 connected to the step portion 40 (i.e., the area of the second optical section 38 with the largest cross-section).

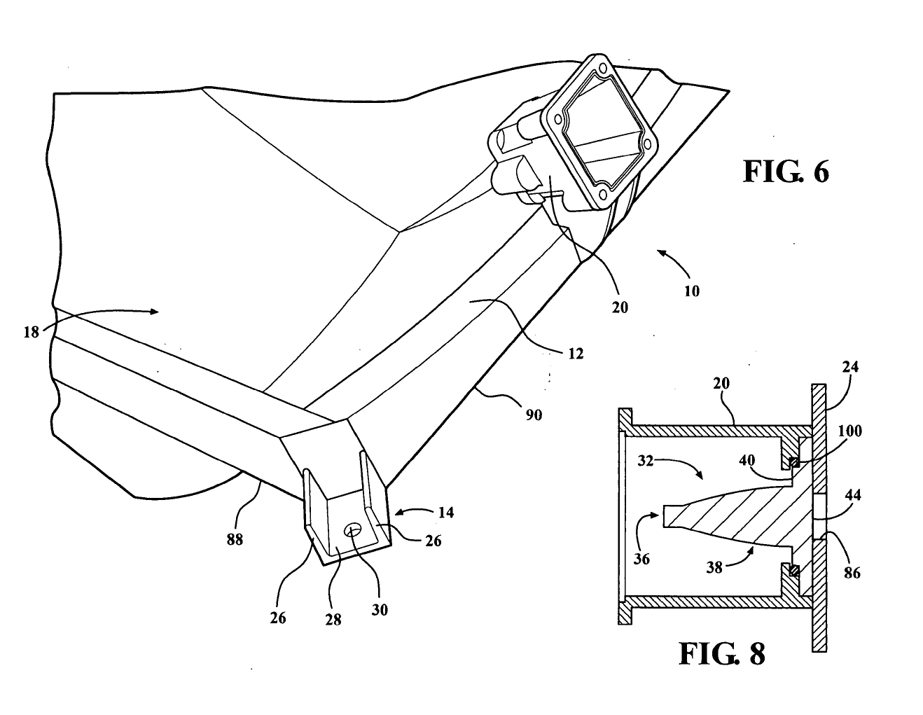

Referring now to FIG. 6, a close up view of the corner of the reflector body molding 12 and incorporated mounting tab 14. The aperture 30 is accessible from the front and lies outside the boundaries of the reflector body molding 12, providing accurate alignment due to the maximized mounting baseline and direct placement on frame rails 16 that could be parallel to either the short edge 88 or the long edge 90 of the reflector body molding 12.

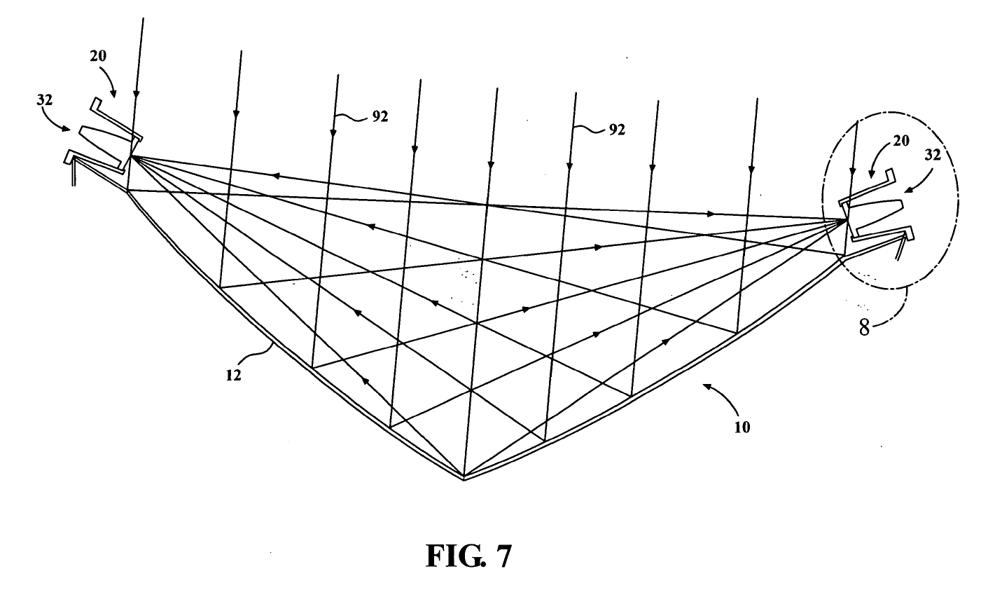

FIG. 7 shows a cross-sectional view through the assembly 10. Sunlight enters the solar concentrator assembly 10 along ray lines 92, and moves as indicated by the arrows. Light bounces off each side and is focused back across the opposite mirror to the corresponding mixing lens 32. This criss-cross light pattern allows each concave mirror surface 18A,18B,18C,18D,18E,18F to function as the support for each corresponding receiver housing 20.

As mentioned above, when assembled, the heat sink solar cell assembly 22, the heatshield/mixing lens retainer 24, the mixing lens 32, and the receiver housing 20 form a light a concentration assembly. In this embodiment, there are several concentration assemblies mounted to the frame rail 16. There is a first concentration assembly 94A, a second concentration assembly 94B, a third concentration assembly 94C, a fourth concentration assembly 94D, a fifth concentration assembly 94E, and a sixth concentration assembly 94F. Each concave mirror surface 18A,18B,18C,18D,18E,18F directs light to a respective concentration assembly.

More specifically, the first concave mirror surface 18A directs light towards the first concentration assembly 94A. The second concave mirror surface 18B directs light towards the second concentration assembly 94B. Furthermore, the third concave mirror surface 18C directs light towards the third concentration assembly 94C, the fourth concave mirror surface 18D directs light towards the fourth concentration assembly 94D, the fifth concave mirror surface 18E directs light towards the fifth concentration assembly 94E, and the sixth concave mirror surface 18F directs light towards the sixth concentration assembly 94F.

Since each concave mirror surface 18A,18B,18C,18D,18E,18F and concentration assembly 94A,94B,94C,94D,94E,94F operates in substantially the same manner, the operation of only one concave mirror surface 18 and concentration assembly 94 will be described. In operation, light received by the concave mirror surface 18A is reflected in the direction indicated by the ray lines 92 such that the light from the concave mirror surface 18A then passes through the central aperture 86 of the heatshield/mixing lens retainer 24, and into the input port 44, where the light then passes through the parabolic optical section 38, and then through the blending optical section 36 and passes out of the output port 34. The light passing out of the output port 34 enters into a solar concentrator 96. Connected to each solar concentrator is a pair of heat sinks 98; however, it is within the scope of the invention that more or less heat sinks 98 may be used.

As can be seen in FIG. 1, there are a total of six concentration assemblies, three of which are mounted on each side of the reflector body molding 12. Each concave mirror surface 18A,18B,18C,18D,18E,18F directs light toward a corresponding concentration assembly 94 on the opposite side of the reflector body molding 12, best indicated by the ray lines 92 shown in FIG. 7. This produces a “criss-cross” pattern of light distribution, allowing the system 10 to be efficient and reduced in size.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. An integrated solar concentrator system, comprising:
a reflector body molding;
a mirror mount surface mounted to said reflector body molding;
at least one concave mirror surface connected to said mirror mount surface; and
at least one light concentration assembly mounted to said reflector body molding;
wherein light is reflected from said at least one mirror mount surface and directed to said at least one light concentration assembly, and said at least one light concentration assembly concentrates said light reflected by said at least one concave mirror surface.

2. The integrated solar concentrator system of claim 1, said light concentration assembly further comprising:
a receiver housing mounted to said reflector body molding;
a mixing lens at least partially disposed in said receiver housing, said mixing lens operable for receiving said light from said at least one concave mirror surface;
a heatshield/mixing lens retainer connected to said receiver housing such that said heatshield/mixing lens retainer maintains the position of said mixing lens in said housing; and
a heat sink solar cell assembly connected to said receiver housing, and said heat sink solar cell assembly receives light from said mixing lens.

3. The integrated solar concentrator system of claim 2, further comprising a frame rail, said frame rail integrally formed with said reflector body molding such that said frame rail at least partially supports said receiver housing.

4. The integrated solar concentrator system of claim 2, said mixing lens further comprising:
an input port;
a first optical section operable for receiving light from said input port;
a second optical section connected to said first optical section such that light passing through said first optical section also passes through said second optical section; and
an output port operable for receiving light from said second optical section, and directing light to said heat sink solar cell assembly.

5. The integrated solar concentrator system of claim 4, said first optical section further comprising a blending optical section operable for blending said light.

6. The integrated solar concentrator system of claim 5, said blending optical section further comprising a plurality of flat tapered walls, each of said plurality of flat tapered walls connected to said output port.

7. The integrated solar concentrator system of claim 4, said second optical section further comprising a parabolic optical section.

8. The integrated solar concentrator system of claim 7, said parabolic optical section further comprising:
at least one parabolic surface; and
at least one flat surface formed as part of said parabolic optical section adjacent said at least one parabolic surface such that said light is focused as said light passes through said parabolic optical section.

9. The integrated solar concentrator system of claim 4, said mixing lens further comprising:
a mounting flange positioned adjacent said receiver housing and supported by said heatshield/mixing lens retainer, said input port formed as part of said mounting flange; and
a step portion integrally formed with said mounting flange and said second optical section such that said second optical section is supported by said step portion.

10. The integrated solar concentrator system of claim 9, said receiver housing further comprising:
a lip portion formed as part of said receiver housing such that said lip portion at least partially surrounds said rear wall portion; and
an inner surface formed as part of said lip portion, said inner surface at least partially surrounds said mounting flange when said mixing lens is connected to said receiver housing;
wherein said mounting flange is disposed between said rear wall portion and said heatshield/mixing lens retainer when said heatshield/mixing lens retainer is connected to said retainer housing.

11. The integrated solar concentrator system of claim 4, said heatshield/mixing lens retainer further comprising a central aperture, wherein light passes through said central aperture before entering said at least one input port.

12. The integrated solar concentrator system of claim 2, said receiver housing further comprising:
a rear wall portion;
an aperture formed as part of said rear wall portion, a portion of said mixing lens extending through said aperture;
a stepped feature formed as part of said rear wall portion such that said stepped feature surrounds said aperture; and
a sealing surface formed as part of said stepped feature;
wherein a seal is disposed between said step portion and said stepped feature when said mixing lens is connected to said receiver housing.

13. The integrated solar concentrator system of claim 2, said receiver housing further comprising a cavity formed as part of said receiver housing, said mixing lens at least partially disposed within said cavity when said mixing lens is connected to said receiver housing.

14. An integrated solar concentrator system, comprising:
a reflector body molding;
a mirror mount surface mounted to said reflector body molding;
at least one concave mirror surface formed as part of said mirror mount surface;
a receiver housing having a cavity, said receiver housing mounted to said reflector body molding;
a mixing lens at least partially disposed in said cavity of said receiver housing, said mixing lens operable for receiving said light from said at least one concave mirror surface;
a heatshield/mixing lens retainer connected to said receiver housing such that a portion of said mixing lens is disposed between said heatshield/mixing lens retainer and said retainer housing; and
a heat sink solar cell assembly connected to said receiver housing, said heat sink solar cell assembly receives light from said mixing lens;
wherein light reflected from said at least one concave mirror surface is directed to said mixing lens, and said light is directed to said heat sink solar cell assembly from said mixing lens.

15. The integrated solar concentrator system of claim 14, said mixing lens further comprising:
an input port;
a parabolic optical section, said light passes through said input port and into said parabolic optical section;
a blending optical section connected to said parabolic optical section, said light passes through said blending optical section after passing through said parabolic optical section; and
an output port connected to said blending optical section such that said light exits said mixing lens through said output port after passing through said blending optical section;
wherein said light is received by said heat sink solar cell assembly from said output port.

16. The integrated solar concentrator system of claim 15, said mixing lens further comprising:
at least one flat tapered wall formed as part of said blending optical section, said at least one flat tapered wall connected to said output port;
at least one parabolic surface formed as part of said parabolic optical section, said at least one parabolic surface connected to said at least one flat tapered surface; and
at least one flat surface formed as part of said parabolic optical section, said at least one flat surface adjacent said at least one parabolic surface and is connected to said at least one flat tapered wall;
wherein said at least one flat surface and said at least one parabolic optical surface focus said light, and said at least one flat tapered wall blends said light.

17. The integrated solar concentrator system of claim 15, said heatshield/mixing lens retainer further comprising a central aperture, wherein light passes through said central aperture before entering said input port.

18. The integrated solar concentrator system of claim 14, further comprising:
a mounting flange formed as part of said mixing lens;
a rear wall portion formed as part of said receiver housing; and
a lip portion having an inner surface, said lip portion formed as part of said receiver housing such that said lip portion surrounds said rear wall portion;
wherein said mounting flange is disposed between said rear wall portion and said heatshield/mixing lens retainer when said heatshield/mixing lens retainer is connected to said receiver housing such that said inner surface surrounds said mounting flange.

19. The integrated solar concentrator system of claim 14, further comprising:
a groove formed as part of said receiver housing; and
a seal disposed in said groove formed as part of said receiver housing such that said seal prevents debris from entering said receiver housing when said heat sink solar cell assembly is connected to said receiver housing.

20. The integrated solar concentrator system of claim 14, further comprising:
a frame rail integrally formed with said reflector body molding;
at least one attachment rib integrally formed with said receiver housing and said frame rail for supporting said receiver housing; and
at least one stiffness flange for providing increased rigidity to said plurality of attachment ribs;
wherein said receiver housing, said at least one stiffness flange, and said at least one attachment rib are molded as a single unit.

21. An integrated solar concentrator system, comprising:
a reflector body molding;
a frame rail integrally formed with said reflector body molding;
a mirror mount surface having at least one concave mirror surface mounted to said reflector body molding;
a receiver housing molded as part of said reflector body molding and mounted to said frame rail;
a mixing lens disposed within said receiver housing, and operable for receiving light from said at least one concave mirror surface;
a heatsink solar cell assembly connected to said receiver housing operable for receiving light from said mixing lens; and
a heatshield/mixing lens retainer mounted to said receiver housing, said heatshield/mixing lens retainer maintains the position of said mixing lens in said receiver housing;
wherein light is reflected off of said at least one concave mirror surface and directed toward said mixing lens, where said light passes through said mixing lens such that said mixing lens focuses and directs said light to said heatsink solar cell assembly.

22. The integrated solar concentrator system of claim 21, said mixing lens further comprising:
a mounting flange supported by said heatshield/mixing lens retainer;
at least one input port operable for receiving light from said at least one concave mirror surface, said at least one input port formed as part of said mounting flange;
a step portion integrally formed with said mounting flange;
a parabolic optical section integrally formed with said step portion, said parabolic optical section operable for focusing said light;
at least one flat surface formed as part of said parabolic optical section;
at least one parabolic surface formed as part of said parabolic optical section adjacent to said at least one flat surface;
at least one output port;
a blending optical section connected to said parabolic optical section, said at least one output port formed as part of said blending optical section, said blending optical section operable for blending said light; and
a plurality of flat tapered walls formed as part of said blending optical section, each of said plurality of tapered walls terminate into one or more of said at least one flat surface and said at least one parabolic surface;
wherein light passes through said input port and said step portion and into said parabolic optical section, and then passes through said blending optical section and out of said output port.

23. The integrated solar concentrator system of claim 22, said heatshield/mixing lens retainer further comprising a central aperture, wherein light passes through said central aperture before entering said at least one input port.

24. The integrated solar concentrator system of claim 22, said receiver housing further comprising:
a rear wall portion;
an aperture formed as part of said rear wall portion;
a stepped feature formed as part of said rear wall portion such that said stepped feature surrounds said aperture;
a sealing surface formed as part of said stepped feature;
a lip portion formed as part of said receiver housing such that said lip portion surrounds said rear wall portion;
an inner surface formed as part of said lip portion, said inner surface at least partially surrounds said mounting flange when said mixing lens is connected to said receiver housing; and
a cavity formed as part of said receiver housing, said mixing lens at least partially disposed within said cavity when said mixing lens is connected to said receiver housing;
wherein said mounting flange is disposed between said rear wall portion and said heatshield/mixing lens retainer when said heatshield/mixing lens retainer is connected to said retainer housing.

25. The integrated solar concentrator system of claim 24, further comprising:
a groove formed as part of said receiver housing; and
a seal disposed in said groove formed as part of said receiver housing such that said seal prevents debris from entering said receiver housing when said heat sink solar cell assembly is connected to said receiver housing.

26. The integrated solar concentrator system of claim 21, further comprising:
at least one attachment rib integrally formed with said receiver housing and said frame rail for supporting said receiver housing; and
at least one stiffness flange for providing increased rigidity to said plurality of attachment ribs;
wherein said receiver housing, said at least one stiffness flange, and said at least one attachment rib are molded as a single unit.
